(19) United States
(12) Patent Application Publication
(10) Pub. No.: US 2004/0078772 A1
(43) Pub. Date: Apr. 22, 2004

(54) Dynamic route exchange

(75) Inventors: Rajesh Balay, Sunnyvale, CA (US); Sanjeev Tyagi, Santa Clara, CA (US)

Correspondence Address: SCHWEGMAN, LUNDBERG, WOESSNER & KLUTH, P.A., P.O. BOX 2938, MINNEAPOLIS, MN, 55402, US

(73) Assignee: CoSine Communications, Inc.

(21) Appl. No.: 10/273,669

(22) Filed: Oct. 16, 2002

(51) Int. Cl. G06F 17/50

(52) U.S. Cl. 716/12

(57) ABSTRACT

Methods, Systems, and Virtual Routers are provided for providing dynamic route exchange between routers. First and second routers are configured to communicate route information to one another. When a new route is detected in the first router, it is dynamically communicated to the second router using a lightweight protocol. Both the sending and receiving routers can apply policies to determine whether routes are to be sent or received. In some embodiments, when a network packet is received and associated with a route that was learned, a router uses an interface reference associated with the route, and by activating the reference the network packet is directed to a next address in a network. In this way, a router need not directly learn routes, but rather a reference can be used to activate an interface that knows how to handle a learned route.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software descriptions/examples, and data as described below and in the drawings hereto: Copyright© 2002, Cosine Communications, Inc., All Rights Reserved.

### FIELD OF THE INVENTION

The present invention is related to dynamic route exchange, and more particularly to dynamic exchanges of routes between routers using lightweight protocols.

### BACKGROUND INFORMATION

In today's highly wired and connected computing environments, networks are often taken for granted by end-users. Yet, heterogeneous networks are often seamlessly and transparently interconnected and made available to the end-users. It is only when a network fails or is degraded that the end-users take notice of the importance associated with having efficient networks.

A network can be configured in many different manners. A Local Area Network (LAN) is a group of computing devices that share a common communications line. Computing and storage resources can be shared within a LAN. Moreover, a LAN can be as small as a few computing devices or as large as an entire enterprise (e.g., office building, office complex, and the like). Another network configuration is a Wide Area Network (WAN). A WAN is a geographically dispersed telecommunications network. A classic example of a well known WAN is the Internet. A third network configuration is a Metropolitan Area Network (MAN), where computing devices are connected in a geographic region or specific area that is larger than a LAN and smaller than the typical WAN. Also, in recent years a new type of Virtual Private Network (VPN) has emerged in the industry. A VPN is a private network that takes advantage of public telecommunications and maintains privacy through use of tunneling protocols and security procedures.

Moreover, networks can be characterized by the type of data transmission technology in use on the networks (e.g., Transmission Control Protocol/Internet Protocol (TCP/IP), and others). Furthermore, the type of data (e.g., voice versus data) that a network can carry can also distinguish the network. Networks are also classified as public or private, by the usual connection techniques used to access the networks (e.g., switched, dial-up, non-switched, dedicated, virtual, and the like), and by the type of physical links used to interface on the networks (fibre optic, coaxial cable, untwisted shielded pair, and the like).

Networks of different types can be interconnected through the use of backbones. A backbone is generally a larger transmission line that carries data gathered from smaller lines that interconnect with it. For example, a LAN may use a backbone to connect with a WAN or to span distances within a single LAN. Further, a WAN may use a backbone as a set of paths that local or regional networks connect to for long-distance interconnections.

When networks are interfaced with one another a number of issues arise. One such issue is how to properly route a received data packet between the networks, since each network may be associated with a different media transmission (e.g., Gigabit Ethernet (GigE), Frame Relay (FR), Time-Division Multiplexing (TDM), Asynchronous Transfer Mode (ATM), and others) and/or a different local data packet-addressing schemes or requirements. Routing or switching devices are used to relay data packets between networks. Often one routing device may know how to relay data packets that a different routing device in the network does not know how to relay. This is so because the routing devices include individual Routing Information Base/Forwarding Information Base (RIB/FIB) tables that include known routes for a specific routing device. Each routing devices accesses its RIB/FIB when a data packet is received in order to determine how to properly relay the received data packet.

Since a network can have a variety of connected sub-networks, many routing devices can be in use with each routing device knowing bow to relay data packets to routes that the other routing devices may not know how to relay. Correspondingly, conventional approaches have attempted to alleviate the disparities between routing information in the RIBs of routing devices within a network by using standard protocols, such as Border Gateway Protocol (BGP), Exterior Gateway Protocol (EGP), and the like. These standard protocols permit the routing devices to send dynamic updates to routes and routing information to one another within the network.

However, these standard protocols are often phrased heavyweight protocols since the use of these protocols are computationally expensive to use by the routing devices and are complex to implement. This is so because the conventional protocols include state information and a variety of error processing information that permits recovery in the event of failure during any particular dynamic communication.

Other approaches learn routes and routing information within a network by using a manual/static approach, where as new routes are learned by one routing device, the other routing devices are manually configured to with the learned route. However, as one of ordinary skill in the art readily recognizes, this technique is not practical for dynamic and time-sensitive networks. Correspondingly, this technique is not often desirable.

In order to build and maintain, scalable and high performance network configurations, the routing devices within the network need to be able to dynamically communicate learned routes with one another. Moreover, the dynamic communication should not tax the processing and memory resources of the routing devices, as is done conventionally with complex heavyweight protocols (e.g., BGP and others). Additionally, BGP is run over Transmission Control Protocol/Internet Protocol (TCP/IP), which requires overhead and additional use of resources.

Therefore, there is a need for techniques that provide improved dynamic communication of routing information between routing devices in a network, that does not employ conventional heavyweight protocols or manual/static techniques.

### SUMMARY OF THE INVENTION

According to one aspect of the present invention, a method to dynamically exchange routes is presented. A first router receives a new route. The first router determines whether the new route is to be dynamically communicated to a second router, where the first router uses a policy associated with the new route to determine that the new route is to be dynamically communicated to the second router. Moreover, the first router uses a lightweight protocol to dynamically communicate the new route to the second router.

According to another aspect of the present invention, a dynamic route exchange system is presented. The dynamic route exchange system includes a first router that dynamically transmits route information from a first Routing Information Base (RIB) to a second router using a lightweight protocol. The dynamic route exchange system also includes an interface reference that is associated with the route information. The route information and the interface reference are dynamically stored in a second RIB of the second router. The second router activates the interface reference when a network data packet is received for a route that is included in the route information of the second RIB. Moreover, by activating the interface reference the next address for the network packet is resolved for the second router.

In yet another aspect of the present invention, a virtual router residing on a computer readable medium is disclosed. The virtual router includes a route information base (RIB), a reference to a virtual interface, and an address to a second virtual router. When new route information is received in the RIB, the virtual router uses the address to dynamically push the new route information to the second virtual router using a lightweight protocol. Furthermore, when the virtual router receives a network that is associated with a route having the reference, then the reference is activated to determine a next-address of the network packet.

### BRIEF DESCRIPTION OF THE DRAWINGS

FIG. 1 shows a diagram of a dynamic route exchange system, according to the present invention;

FIG. 2 shows a flow diagram of a method for dynamically exchanging routes, according to the present invention; and

FIG. 3 shows a diagram of virtual router, according to the present invention.

### DESCRIPTION OF THE PREFERRED EMBODIMENTS

In the following detailed description of various embodiments of the present invention, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

As used herein, a router refers to physical routing devices, or virtual routers that are implemented primarily with software instructions to logically function as physical routing devices. The routers include, among other things, RIBs, access to memory (volatile and/or non-volatile), and access to one or more processors. Thus, the routers are capable of executing software instructions. In one embodiment, the virtual routers are configured and distributed by Cosine Corporation and modified to provide the tenets of the present invention. Of course, any physical or virtual routing device is intended to fall within the scope of the present invention, when the teachings of the present invention are included therein.

Additionally, lightweight protocols are protocol techniques that provide simple messaging capabilities that do not include the complexity and overhead associated with heavyweight protocols (e.g., BGP/TCP/IP, and the like). Lightweight protocols are known to one of ordinary skill in the art. Correspondingly, all conventional or ad-hoc developed lightweight protocol is intended to fall within the scope of the present invention.

In various embodiments of the present invention, routers are configured to communicate with one another using a lightweight protocol. The RIBs of the routers include route information (e.g., routes and metadata), which can be different from one router to another router. Policies within each router determine whether route information from one router's RIB will be dynamically transferred to another router. Moreover, a receiving router of route information can use policies to determine whether to accept the new route information and update its RIB to include the new route information.

In one embodiment of the present invention, a receiving router of new route information from does not need to learn all the particulars associated with the received route information. This can be achieved by associating a reference with any learned route information, where the reference is a pointer to an interface that can determine the next address associated with a network packet that is received and assigned to the received route information. In this way, a receiving router identifies a route in the received route information for a received network packet, and in order to resolve the next address for the network packet the reference pointer is activated to execute the interface. Of course, the receiving router can resolve the next address of a received network packet that is associated with received route information with other techniques. All such techniques are intended to fall within the broad scope of the present invention.

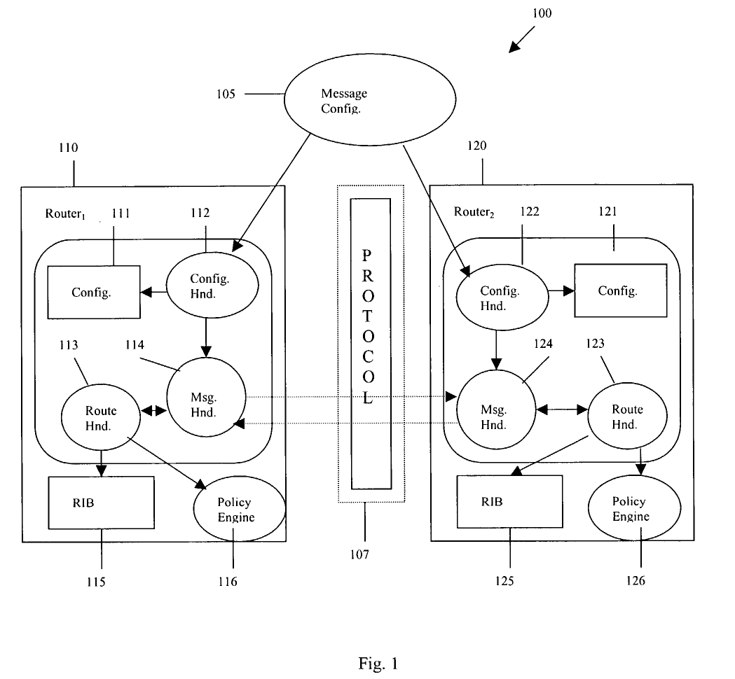

FIG. 1 illustrates a diagram of one dynamic route exchange system 100, according to the present invention. The dynamic route exchange system 100 includes a first router 110 and a second router 120. Each router 110 or 120 includes configuration data 111 or 121 that is defined and customized via a configuration handling application 112 or 122. A message configuration application 105 provides to the configuration handling applications 112 and 122 the appropriate thin protocol (e.g., lightweight protocol) 107 that the first router 110 and the second router 120 are to use when communicating with one another.

The configuration handling applications 112 and 122 provide the messaging protocol information to message handling applications 114 and 124. The message handling applications 114 and 124 directly communicate with one another via the established messaging technique using a thin or lightweight protocol 107. Moreover, the message handling applications 114 and 124 communicate with their respective route handling applications 113 and 123. The route handling applications 113 and 123 have access to their respective policy engine applications 116 and 126. Furthermore, the route handling applications 113 and 123 directly access the RIBs 115 and 125 for their respective routers 110 and 120

The Route handler 113 of the first router 110 detects when route information (e.g., routes and metadata about routes) is added or modified in RIB 115. The route handling application 113 passes any newly added or modified route to the message handling application 114. In some embodiments, the route handling application 113 checks with the policy engine application 116 before passing the route to determine whether the route can be permissibly transferred from the first router 110 to the second router 120. The policy engine application includes rules as to whether routes should be communicated to other routers. For example, some rules may indicate that only public routes of the first router 110 are to be transferred. Alternatively, rules can indicate that only route identifications are to be transferred.

The policy engine application 116 and its associated rules can be configured using the configuration handling application 112. If a route is to be communicated to the second router 120, then the message handling application 114 dynamically pushes the route to the message handling application 124 of the second router 120. When the route is received on the second router 120, it is passed to the route handling application 123. The route handling application 123 then checks its policy engine application 126 to determine whether the route can be added to RIB 125 on the second router 120.

In some embodiments, the received route on the second router 120 is added to RIB 125 with the following metadata: route-type is set to direct, next-hop Internet Protocol (IP) address is set to “0.0.0.0,” RouteProto is set to netmgt or STATIC. The route-type that is set to direct will include a reference pointer to an interface that is associated with the first router 110. When the second router 120 activates the reference pointer, the interface executes to resolve the next address of any network packet associated with the route. In this way, the second router 120 does not need to know all the particulars on how to resolve the next address for any received network packet associated with a route learned from the first router 110, rather an interface pointer is used to activate an interface that does know how to resolve the next address of the network packet.

Moreover, in some embodiments, when a state associated with the interface moves from a down state to an up state a complete update of route information is dynamically pushed from the first router 110 to the second router 120, using the message handling applications 114 and 124. Additionally, when an individual route's states changes from ACTIVE to some other state an incremental update for that particular route can be dynamically pushed from the first router 110 to the second router using the message handling applications 114 and 124.

Furthermore, standard API's can be used to communicate with other routers. For example, an IOCTL API can be similar to that used for Managed Information Bases (MIBs), where the IOCTL API is extended to include the sending routers identification and routing information. Alternatively, routers can use the interface described above to communicate route information, and if the interface is used then the specific sending and receiving routers are readily identifiable by the routers.

Inter-router communication can use any thin/lightweight protocol that uses the socket layer. In one embodiment, Transmission Control Protocol/Internet Protocol (TCP/IP) socket layer is used. In other embodiments, a raw socket layer can be used making use of Remote Function Calls (RFCs).

Additionally, in some embodiments, the message configuration application 105 is used to initially establish the thin/lightweight protocol 107 that will be used between the first router 110 and the second router 120. In some embodiments, the thin/lightweight protocol 107 makes use of a Short Message Service (SMS). Thus, communications between the first router 110 and the second router 120 are not heavyweight protocols that are computationally taxing and complex to implement. In this way, the teachings of the present invention is easy to implement and requires less resources of the routers 110 and 120 in communicating and learning route information than what has been done conventionally using BGP/TCP/IP.

Further, during configuration the customer's router and the SP's router are configured with an interfaces or a reference to interfaces, where the customer router's reference is to an interface that the SP's router defines for resolving routes and where the SP's reference is to an interface that the customer's router defines for resolving routes. In this way, each router 110 and 120 has access to an interface that can resolve the next address for a packet when the packet is associated with a route that is learned from the other router 110 or 120. In some embodiments, the interfaces are virtual interfaces.

In one embodiment the first router 110 is a customer router 110 of a Service Provider (SP). The second router 120 is a router of the SP. When the customer router 110 is initially configured using the message configuration application 105 to communicate the configuration handling application 112, the thin/lightweight protocol 107 is established for message communications between the customer's router 110 and the SP's router 120. Also, references to each router's interface are established during configuration. Moreover, the configuration handling application 112 customizes the rules for the policy engine application 116 in order to establish which types of routes that will be dynamically pushed from the customer's router 110 to the SP's router 120.

The customer router's route handling application 113 and/or message handling application 114 then listens for updates and additions to RIB 115. And, when a new route that conforms to the rules in the policy engine application 116 is detected, it is dynamically pushed to the SP's router 120 using the thin/lightweight protocol 107.

Therefore, complex logic is decoupled from the routers 110 and 120, and yet the routers 110 and 120 can still learn routes from one another and efficiently handle those learned routes when network packets are received that are associated with the learned routes. Moreover, when a router 110 or 120 detects that its interface has moved from a down state to an up state, the router 110 or 120 can dynamically push a complete RIB 115 or 125 update to the other router 110 or 120. For efficiency, incremental updates are pushed from one router 110 or 120 to the other router 110 or 120 when a single route's status changes from an ACTIVE state. Thus, the routers 110 and 120 can dynamically ensure synchronization with one another.

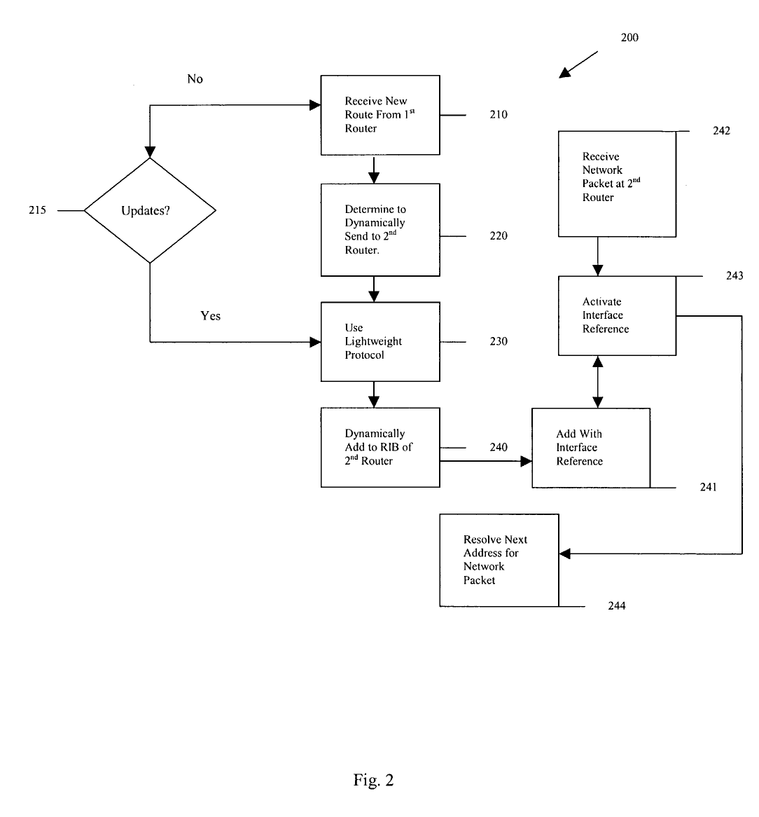

FIG. 2 shows a flow diagram of one method 200 for dynamically exchanging routes in the dynamic route exchange system 100, according to the present invention. Initially, a first router 110 and a second router 120 are configured to communicate with one another. During configuration a thin/lightweight protocol 107 is established along with interfaces pointers, such that the first router 110 includes an interface pointer to an interface of the second router 120, and the second router 120 includes an interface pointer to an interface of the first router 110. The interfaces know how to determine the next address associated with network packets that are destined for routes of the routers 110 and 120. In some embodiments, the routers 110 and 120 are virtual routers logically representing physical routing devices. Moreover, in some embodiments, the interfaces are virtual interfaces.

At 210, the first router 110 receives a new route in its RIB 115. The first router 110 uses its route handling application 113 to check the policy engine application 116 in order to determine, at 220, whether the new route is to be dynamically communicated or pushed from the first router 110 to a second router 120. If the new route conforms to the rules of the policy engine application 116, then at 230 the thin/lightweight protocol is used by message handling application 114 to dynamically push the new route to message handling application 124 of the second router 120.

The message handling application 124 passes the new route to route handling application 123, which performs a check with policy engine application 126 to determine if the new route can be added to RIB 125. If the new route conforms, then at 240 the new route is dynamically added to RIB 125. Moreover, at 241, the new route is added to RIB 125 with metadata that includes an interface reference to the interface of the first router 110 that was established during configuration of the first router 110 and the second router 120.

After the second router 120 has successfully and dynamically added route information (e.g., the new route and its metadata) to RIB 125, then the second router 120 is now ready to accept and handle network packets that are associated with the new route that was dynamically learned by the second router 120. Accordingly, at 242, the second router 120 receives a network packet associated with the new route, and at 243 the second router 120 activates its interface reference, which activates the first router's interface. Thus, at 244, the received network packet has its next network address resolved by the first router's interface.

Additionally, the first router 110 can communicate updates from its RIB 115 to the RIB 125 of the second router 120. For example, route handling application 113 and/or message handling application 114 can listen for changes in state in RIB 115 and for changes in state to the interface of the first router 110. At 215, when a change is detected a complete RIB 115 update can be sent to RIB 125 if the interface's state changes from down to up. Moreover, an incremental update can be sent for a specific route when the specific route's ACTIVE status changes. Therefore, RIB 115 and 125 can be efficiently and dynamically kept in synch. Furthermore, all updates are communicated using the thin/lightweight protocol.

As is now apparent to one of ordinary skill in the art, routers can communicate and learn routes from one another more efficiently by using the teachings of the present invention. Moreover, complex heavyweight protocols (e.g., BGP/TCP/IP) need not be implemented to achieve dynamic communications between the routers. Thus, routers implementing the tenets of the present invention are more flexible and use fewer resources to communicate with one another, the increased availability of resources permit the routers to utilize resources for handling increased control plane traffic/activity.

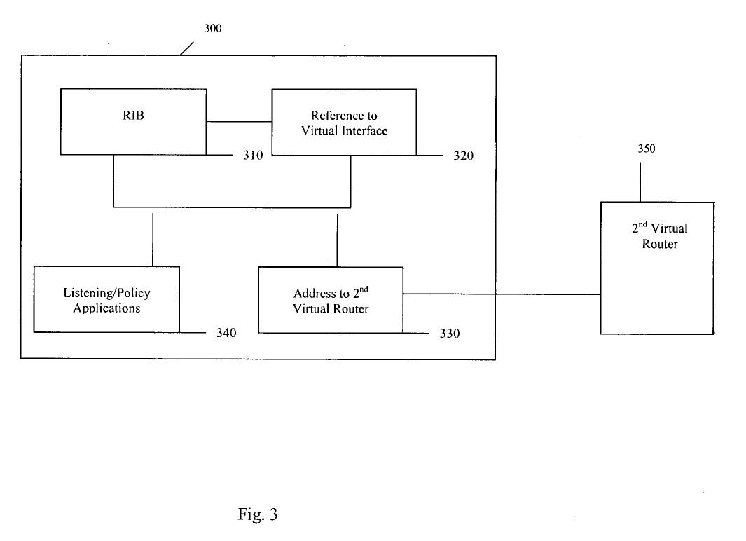

FIG. 3 shows a diagram of one virtual router 300, according to the present invention. The virtual router 300 resides in a computer readable medium or a plurality of computer readable media. The virtual router 300 logically represents a physical routing device. Unlike a physical routing device, however, the virtual router 300 can be configured and more easily modified since it is not tied to any particular device or set of resources within a device.

The virtual router 300 includes a RIB 310, a reference to a virtual interface 320 associated with a second virtual router 350, and an address or identifier for the second virtual router 350. The reference 320 and the address 330 are configured with values when the virtual router 300 is initialized. The reference 320 when activated executes an interface application that the second virtual router 350 uses to resolve the next address of network packets received for routes known to the second virtual router 350.

When the virtual router 300 receives new route information (e.g., routes and metadata associated with the routes), the virtual router 300 uses applications processing in the virtual router 300 to dynamically push the new route information to the second virtual router 350 using a thin/lightweight protocol for communication with the second virtual router 350. In some embodiments, a listening application 340 detects when new route information is present in RIB 310 and raises an event that causes other applications within the virtual router 300 to be activated. One such application, is a policy application 340 that ensures the new route information conforms with rules that permit the virtual router 300 to dynamically communicate the new route information to the second virtual router 350.

In some embodiments, the listening application 340 also detects when updates from RIB 310 need to be dynamically pushed to a RIB of the second virtual router 350. For instance, when an interface associated with virtual router 300 moves from a down state to an up state, applications processing on the virtual router 300 can cause a complete update of RIB 310 to be dynamically pushed to the RIB of the second virtual router 350. Moreover, when an ACTIVE state of a single route in RIB 310 changes an incremental update for the changed route can be dynamically pushed from the virtual router 300 to the RIB of the second virtual router 350. In this way, the virtual router 300 is capable of dynamically keeping the routes that it desires to communicate to the second virtual router 350 in synchronization.

Furthermore, when the virtual router 300 can learn routes and route information from the second virtual router 350 in the same way that it communicates new route information to the second virtual router 350. For example, when the virtual router 300 receives a new route from the second virtual router 350, the virtual router accesses its policy application 340 to first determine if it is permissible for the virtual router 300 to learn the dynamically communicated new route. And, if it is permissible to learn the new route, then the new route is added to RIB 310 along with the reference to the virtual interface 320 associated with the second virtual router 350.

Next, when the virtual router 300 receives a network packet addressed to a learned route, the virtual router 300 activates the reference to the virtual interface 320 which causes the virtual interface of the second router to execute and provide the next network address of the network packet to the virtual router 300. Thus, the virtual router 300 need not know are the articulars on how to handle a learned route, rather the virtual interface of the second virtual router 350 performs the necessary processing.

### Conclusion

Methods, systems, and virtual routers detailed above permit improved dynamic route communication between routes. These methods, systems, and virtual routers utilize lightweight protocol communications as opposed to conventional heavyweight protocols (e.g., BGP/TCP/IP). Thus, the teachings of the present invention provide for improved networks that are more scalable and provide better performance, since resources typically needed to accommodate heavyweight protocol communications are now reallocated within the network to handle other processing needs.

Although specific embodiments have been illustrated and described herein, it will be appreciated by one of ordinary skill in the art that any arrangement that is calculated to achieve the same purpose may be substituted for the specific embodiments shown. This application is intended to cover any adaptations or variations of the present invention. Therefore, it is intended that this invention be limited only by the claims and the equivalents thereof.

What is claimed is:

1. A method to dynamically exchange routes:
receiving a new route, wherein the new route is received by a first router;
determining that the new route is to be dynamically communicated to a second router, wherein the first router uses a policy associated with the new route to determine that the new route is to be dynamically communicated to the second router; and
using a lightweight protocol to dynamically communicate the new route to the second router.

2. The method of claim 1 further comprising dynamically adding the new route to a router information base (RIB) table of the second router.

3. The method of claim 2, wherein in dynamically adding the new route, the new route is added with an interface pointer that points to an interface that the second router is to use when receiving network packets associated with the new route, the interface resolves a next-hop address for the network packets.

4. The method of claim 3 further comprising dynamically pushing a complete update associated with the new route from the first router to the second router when a state associated with the interface changes from a down state to an up state.

5. The method of claim 3 further comprising, dynamically pushing an incremental update associated with the new route from the first router to the second router when an active status associated with the new route changes.

6. The method of claim 1, wherein in receiving, the first router is a virtual router associated with a customer of a service provider (SP).

7. The method of claim 1, wherein in determining, the second router is a virtual router associated with a SP.

8. A dynamic route exchange system, comprising:
a first router that dynamically transmits route information from a first Routing Information Base (RIB) to a second router using a lightweight protocol;
an interface reference that is associated with the route information, wherein the route information and the interface reference are dynamically stored in a second RIB of the second router; and
wherein the interface reference is activated by the second router when a network data packet is received for a route that is included in the route information of the second RIB, and wherein by activating the interface reference the next address for the network packet is resolved for the second router.

9. The dynamic route exchange system of claim 8, wherein a complete update of the route information is received by second router when a state associated with the interface changes from a down state to an up state.

10. The dynamic route exchange system of claim 8, wherein the second router receives an incremental update associated with a portion of the route information when an active status of the route changes.

11. The dynamic route exchange system of claim 10, further comprising a first policy and a second policy, wherein the first router uses the first policy to decide whether the route information is to be transmitted to the second router, and wherein the second router uses the second policy to decide whether to store the route information in the second RIB.

12. The dynamic route exchange system of claim 8, wherein the first and second routers are virtual routers and the interface is a virtual interface.

13. The dynamic route exchange system of claim 8, wherein the first and second routers are initially configured to use the interface for resolving routes between each other.

14. A virtual router residing on a computer readable medium, comprising:
a route information base (RIB);
a reference to a virtual interface;
an address to a second virtual router; and
wherein when new route information is received in the RIB, the virtual router uses the address to dynamically push the new route information to the second virtual router using a lightweight protocol, and when a network packet is received by the virtual router that is associated with a route having the reference then the reference is activated to determine a next-address of the network packet.

15. The virtual router of claim 14, further comprising a policy application engine that is used to determine whether the new route information is pushed to the second virtual router, and wherein the policy application engine is used to determine whether the reference is activated when the network packet is received.

16. The virtual router of claim 15, a listening application that listens for updates to the RIB of the virtual router and listens for updates to a second RIB associated with the second virtual router.

17. The virtual router of claim 16, wherein a complete update of the new route information is dynamically pushed to the second virtual router when the virtual interface goes from a down state to an up state.

18. The virtual router of claim 14, wherein an incremental update associated with a portion of the route information is dynamically pushed to the second virtual router when an active state associated with a new route included in the route information changes from an active status.

19. The virtual router of claim 14, wherein the virtual router is configured to dynamically push at least one of a public route and a route identification included within the route information.

20. The virtual router of claim 14, wherein the route information is exported from the RIB to a second RIB associated with the second virtual router when dynamically pushing the route information from the virtual router to the second virtual router.
